(19) United States
(12) Patent Application Publication
(10) Pub. No.: US 2025/0384465 A1
(43) Pub. Date: Dec. 18, 2025

(54) Multimodal Content Item Personalization Based on User Profiles

(71) Applicant: Google LLC, Mountain View, CA (US)

(72) Inventor: Laurynas Tamulevicius, Zurich (CH)

(21) Appl. No.: 19/240,718

(22) Filed: Jun. 17, 2025

Related U.S. Application Data
(60) Provisional application No. 63/661,360, filed on Jun. 18, 2024.

(51) Int. Cl. G06Q 30/0251

(52) U.S. Cl. CPC G06Q 30/0269

(57) ABSTRACT

Methods, computing systems, and technology for automatically generating media assets and content items are presented. The method can include obtaining a plurality of assets of a content provider, the plurality of assets comprising a text asset, an audio asset, an image asset, and a video asset. Additionally, the method can include obtaining, from a content item database, a first content item of the content provider. Moreover, the method can include determining a plurality of user groups for the first content item. Furthermore, the method can include processing, using a machine-learned model, the plurality of assets, the first content item, and a first user group from the plurality of user groups to generate the new content item, wherein the new content item is tailored to the first user group. Subsequently, the method can include storing the new content item in the content item database.

### PRIORITY CLAIM

The present application claims the benefit of priority of U.S. Provisional Patent Application No. 63/661,360 filed on Jun. 18, 2024, which is incorporated by reference herein.

### FIELD

The present disclosure relates generally to automatically generating content items or media assets based on a user profile.

### BACKGROUND

A communication campaign can leverage a multi-modal, multi-platform distribution system to distribute content items to various endpoints for various audiences. The content items can contain data or other information or messages. The content items can be or include media assets. A user can create a communication campaign by providing the multi-modal, multi-platform distribution system with a set of content items for distribution.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for generating a new content item for a video platform. The method can include obtaining a plurality of assets of a content provider, the plurality of assets comprising a text asset, an audio asset, an image asset, and a video asset. Additionally, the method can include obtaining, from a content item database, a first content item of the content provider. Moreover, the method can include determining a plurality of user groups for the first content item. Furthermore, the method can include processing, using a machine-learned model, the plurality of assets, the first content item, and a first user group from the plurality of user groups to generate the new content item, wherein the new content item is tailored to the first user group. Subsequently, the method can include storing the new content item in the content item database.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a diagram of a machine-learned media asset generation pipeline according to example embodiments of the present disclosure.

FIG. 2 depicts a block diagram of an offline processing schema according to example embodiments of the present disclosure.

FIG. 3 depicts a flow chart diagram of an example method to a new content item according to example embodiments of the present disclosure.

FIG. 4 depicts a flow chart diagram of an example method to generate a second content item according to example embodiments of the present disclosure.

FIG. 5A depicts a block diagram of an example computing system that performs guided content generation according to example embodiments of the present disclosure.

FIG. 5B depicts a block diagram of an example computing device that performs guided content generation according to example embodiments of the present disclosure.

FIG. 5C depicts a block diagram of an example computing device that performs guided content generation according to example embodiments of the present disclosure.

Reference numerals that are repeated across plural figures are intended to identify the same features in various implementations.

### DETAILED DESCRIPTION

### Overview

Generally, the present disclosure is directed to automatically generating content items based on a user profile. Example implementations provide for generating, using a machine-learned model, a content item based on a user profile by instructing a machine-learned model to generate a content item that aligns with preferences of the user. Example techniques include automatically generating a plurality of content items for a video platform and selecting a content item from the plurality of content items based on the user profile of the user.

Content items for a video platform, such as YouTube, can include a set of static assets such as image, headline, description, video or audio. Content providers can provide several versions of assets, such as alternative images and headlines. During a content item candidate retrieval process, the content item is generated from the static assets by applying various selection criteria to optimize for predetermined objectives (e.g., relevance, engagement). However, in most cases it can be difficult to find the right set of assets to accurately respond to a user profile or their intentions (such as search query), thus the content item becomes very generic or not relevant in the user context.

The system described herein utilizes the advancements in generative artificial intelligence (AI) to personalize the static assets and generate content items that are more relevant and engaging. In some instances, the system can modify different types of static assets to be personalized for a specific user or group. The different types of static assets that can be modified include text, image, video, and audio assets. The system can modify text assets by rewriting headlines of a content item in real-time (e.g., online process) by using machine learning models to incorporate user search query signals. However, the efficiency of updating text assets can be limited because of online inference costs. To reduce the online inference costs, the system modifies the text asset at a much later stage after the asset selection which can reduce the effectiveness of the content item. Additionally, online rewrite can be expensive so state-of-the-art machine learning models may not be used. The system can also modify image, video, and/or audio assets. The system can utilize multimodal generative AI models to modify image, video, and/or audio assets.

According to embodiments described herein, the system can utilize the capabilities of generative AI models which take multimodal inputs and enhance them based on provided profiles. The system can include a database of a set of similar (e.g., common) user profiles which could be utilized to personalize the static assets offline. The system can utilize deep neural networks to modify the assets based on a selected user profile.

In some instances, the system can modify the static assets using an offline process. For example, for every group, the system can determine the interaction and user logs for engagement metrics. The system can create a temporary table with most engaged users. The system can fetch the user profiles from the user profile database. The system can join the table of the most engaged users with the user profiles and group them into similar profiles. We select top N user profiles.

Additionally, for every ad group, the system fetches static assets provided by content providers from the content item database. The content item database includes a plurality of content items that are received from content providers.

Moreover, the system can input the user profile and the static assets in a machine-learned model to generate a tailored asset for a specific user. Subsequently, the generated assets are stored in the content item database to be used during the next asset retrieval request.

In some instances, the continuous offline pipeline would run periodically (e.g., every few hours) to incorporate new engagement statistics and generate assets. Furthermore, a human evaluation pipeline can be utilized to monitor the quality of generated content.

In some implementations, the techniques disclosed herein enable techniques for enabling artificial intelligence to generate content items based on user profile. Artificial intelligence (AI) is a segment of computer science that focuses on the creation of intelligent agents that can learn and perform tasks autonomously (e.g., without little to no human intervention). Artificial intelligence systems can utilize, for example, one or more of (i) machine learning, natural language processing, and computer vision. Machine learning, and its subsets, such as deep learning, focuses on developing models algorithms that can infer outputs learned from data. The outputs can include, for example, predictions and/or classifications. N, (ii) natural language processing, which focuses on analyzing understanding and generating human language. C, and/or (iii) computer vision, which is a field that focuses on analyzing, understanding and interpreting images and videos. Artificial intelligence systems can include generative models that generate new content, such as (e.g., images, videos, text, audio, and/or other content), in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be back propagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts, etc.) can be used to improve the generalization capability of the models being trained.

The model(s) can be pre-trained before domain-specific alignment. For instance, a model can be pre trained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data and may be further updated or refined during their use based on additional feedback/inputs.

The system, using a machine-learned model, can automatically infer user preferences based on user data that is derived from social, video channels, public information, past published content, past sponsored content, and so on. The machine-learned model can generate a content item tailored to a specific user based on the user data.

According to some embodiments, the system can generate a new content item by enhancing images and videos, improving asset quality to, auto generated assets in a plurality of formats. Content providers, by providing user feedback, can adjust one or more parameters to improve a content item.

The plurality of user profiles can include data associated with a communicative personality for a user profile, performance data from any past campaigns, and learned trends or features of the user profiles The user profiles can be maintained dynamically as campaigns are distributed and updated, as campaign communications are received and used by the recipient endpoints. The user profiles can be updated dynamically as the user interacts with the machine-learned models based on preferences, selections, inputs, signals.

The system can collect additional input signals from the user. The additional input signals can be persisted in association with the user profile. The additional input signals can include metadata indicating whether a particular signal was manually modified by a user. This can improve latency and decrease processing requirements. In this manner, for instance, the machine-learned model can learn from user inputs/corrections and avoid making the same errors with respect to future campaigns.

The system can process data parsed from the data resource, the account profile data, and the additional input signals to generate content items for use in the communication campaign. The campaign generation system can implement a machine-learned model to retrieve or modify pre-existing media assets, generate new media assets, or retrieve new media assets from a database, guided by the account profile data and additional input signals. For instance, the machine-learned model can generate images, headlines, descriptions, videos, logos, color palettes, sitelinks, and visual styles and themes. The machine-learned media model can retrieve or modify pre-existing images, headlines, descriptions, videos, logos, color palettes, sitelinks, and visual styles and themes. The machine-learned media model can query relevant databases to obtain new images, headlines, descriptions, videos, logos, color palettes, sitelinks, and visual styles and themes.

The content item database can include assets used in past campaigns, assets uploaded or generated but not yet used. The content from the content item database can be modified or optimized. For instance, images or videos can be resized, text overlays on images or videos can be removed and infilled (e.g., using machine-learned inpainting models), images or videos can be edited (e.g., exposure, coloration, sharpness). Text media assets can be rephrased and edited for clarity. Logos can be identified, rescaled, optimized for overlays (e.g., removing a background, generating an alpha channel), and/or recolored.

The machine-learned model can generate a content item based on user profile data. The machine-learned model can use a machine-learned natural language understanding model to parse text in an asset or content item to understand the content of the data resource and learn about the context in which the content is presented.

The machine-learned model can generate images and videos that are based on and align with a specific user profile. Various image generation architectures can be used, including convolution neural networks, transformers, generative adversarial networks, and diffusion models. The image generation models can process, as example inputs, images from the data resource to prompt the models to generate similar images, text descriptions of desired images and other signals or instructions, learned soft prompts. For instance, images from the content item database can be provided to the image generation model(s) to prompt the model(s) to include the product in the generated images, to outpaint around the product in a new environment. This is one example of a technique to contextualize or re-contextualize product imagery while improving faithful reproduction of the product attributes. Other example techniques for image asset generation include processing attributes and data resource to extract attributes (subjects, colors, mood), using a machine-learned language model to generate a prompt based on the asset generation instructions and the extracted attributes, and inputting the prompt or the asset generation instructions and the prompt to the image generation model.

Examples of the disclosure provide several technical effects, benefits, and/or improvements in computing technology and artificial intelligence techniques that involve the use of machine learning algorithms to generate new data, such as images, audio, text, video, or other types of media. The techniques described herein improve the use of generative models by improving the quality of the generated content. The quality of the generated content is tailored specifically to a specific user group. For example, by using more content-relevant data, the system improves the performance of generative models. Additionally, the system utilizes better training techniques by developing more efficient and effective training techniques that are specific to the user group to reduce the time and resources required to train models. Moreover, the system can incorporate user feedback and provide the feedback, via reinforcement learning or active learning, to generative models that can help the models learn from user preferences and improve over time. Furthermore, the present disclosure can reduce processing by reducing the number of manual inputs provided by a user and by reducing the number of interface screens which must be obtained, loaded, interacted with, and updated. For example, the user may only have to input a web address of a website, and the system can automatically extract content from the website and automatically generate content items for the user.

With reference now to the Figures, example embodiments of the present disclosure will be discussed in further detail.

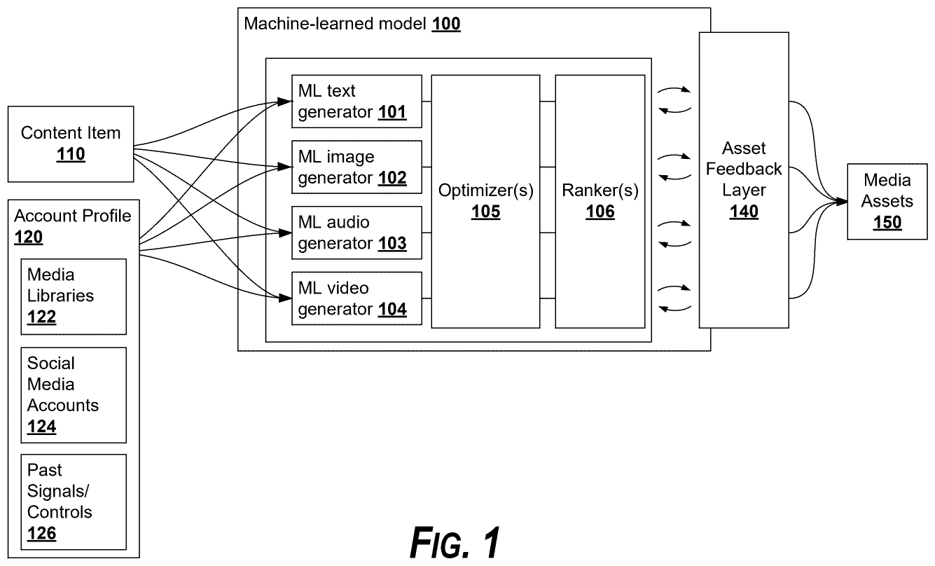

FIG. 1 depicts an example system for implementing a machine-learned model 100. Machine-learned model 100 can include a machine-learned text generator 101. Machine-learned model 100 can include a machine-learned image generator 102. Machine-learned model 100 can include a machine-learned audio generator 103. Machine-learned model 100 can include a machine-learned video generator 104. Machine-learned model 100 can include one or more optimizer(s) 105 to apply one or more optimization algorithms to the outputs of any one or more of machine-learned generator models 101 to 104. Machine-learned model 100 can include one or more rank(s) 106 to rank outputs of any one or more of machine-learned generator models 101 to 104.

Machine-learned model 100 can ingest data from a content item 110 and data from an account profile 120. Account profile 120 can include user preferences. Account profile 120 can include media libraries 112. Account profile 120 can include social media accounts 124. Account profile 120 can include past signals/controls 126 input to the machine-learned model 100. Machine-learned model 100 can process the data retrieved from data resource 110 and account profile 120.

Machine-learned model 100 can include an asset feedback layer 140. Asset feedback layer 140 can facilitate input of user feedback on generated assets and initiate generation of updated or different assets. After selection, confirmation, or approval using asset feedback layer 140, machine-learned model 100 can output media assets 150. Media assets 150 can include any type of media asset output.

The machine-learned model can use a text generation model to generate text that is based on and aligns with the user profile. Various text generation architectures can be used, including convolution neural networks, transformers, generative adversarial networks, and diffusion models. An example architecture includes encoder-only, encoder-decoder, or decoder-only transformer-based models trained over large text corpora. The text generation models can process, as example inputs, images from the data resource to prompt relevant descriptions, textual prompts describing desired output text and other signals or instructions, learned soft prompts.

The machine-learned model can use a video generation model to process the user data to generate videos that are based on and align with the specific user profile. Various video generation architectures can be used, including convolution neural networks, transformers, generative adversarial networks, diffusion models, continuous or discrete time cascaded diffusion models.

The machine-learned model can use an audio generation model to process the user data to generate audio that is based on and aligns with the specific user profile. Various audio generation architectures can be used, including convolution neural networks (e.g., processing spectrograms), transformers (e.g., processing sequences of audio data or embeddings thereof), generative adversarial networks, diffusion models, continuous or discrete time cascaded diffusion models.

The machine-learned model can optimize content items. Optimization can include cropping, inpainting, outpainting, upscaling, recoloring, sharpening, or other modifications. Optimization can be implemented by one or more machine-learned models (e.g., image editing models, video editing models, audio editing models). Optimization can be logged in metadata. Optimization steps can be rolled back by reloading a saved state of the asset from the metadata.

The machine-learned model can rank content items for each user profile. For instance, a machine-learned model can rank content items based on a likelihood of performance of the content item in the communication campaign (e.g., a predicted likelihood of a user interacting with a corresponding content item to execute a hyperlink embedded in the content item). The ranking can be based on a source of the image (e.g., system-generated, crawling from the data resource, user-uploaded). The ranking can be based on an image recognition result (e.g., images recognized to be of a product described on the data resource). The ranking can be based on an alignment with the additional signals input by the user. Ranking can also be performed based on best practices. A machine-learned model can be trained to identify best practices for media assets. Heuristic-based best practices can also be checked. A best practices score can be provided. The score can be based on an estimated performance lift (e.g., for a particular audience). For instance, it might be determined that positioning a product in the center of a media asset tends to see a measurable increase in website visits. Based on the ranking, the machine-learned model can select a generated content item from the plurality of content items in the content item database to present to the user. For instance, top-ranked content items can be selected for presentation. A top-K set of content items can be selected. A sampling of content items can be selected from different rank positions (e.g., to be more robust to ranking error).

The system can solicit user feedback regarding the generated content items. The system can provide a user interface presenting the content items with interactive input elements provided for editing the content items. The system can provide a user interface presenting input fields for providing natural language instructions for changes to be made to the content item. User feedback can be input back into the machine-learned model to re-generate or re-modify the content item according to the feedback signals. This can be performed iteratively until the user approves of the media assets. User feedback can be obtained using a conversational input interface. For instance, a speech or text natural-language input and output interface can be provided to receive user input in natural language and implement the requested changes. The system can also generate outputs in natural language to describe the updates that have been performed.

User feedback and selections can provide training data for improving one or more components of the machine-learned model. For instance, a loss, reward, or penalty can be based on the user feedback and selections. The system can train one or more components of the machine-learned model to decrease the loss, increase a reward, or decrease a penalty. Training techniques can involve supervised training (e.g., with supervision provided by the user inputs), unsupervised training (e.g., learning patterns of account behavior to optimize outputs based on those patterns), reinforcement learning (e.g., the asset generation pipeline as the reward-secking agent).

The system can process media assets to generate content items using the media assets. For instance, the system can combine text assets (e.g., headlines, taglines, descriptions) with image assets (e.g., product images, background images) to create a content item for distribution. The system can generate content items based on a likelihood of utilization of the content item. For instance, utilization of the content item can include interacting with the content item to execute a hyperlink embedding in the content item. For instance, the hyperlink can direct an endpoint device to the data resource using the resource locator.

Generated content items can be processed by a policy check. For instance, a policy check system can evaluate generated output for any sensitive material (e.g., material that is against a platform policy). The generated content item that violates the policy can be screened out and not presented to the user. A policy check system can be applied on inputs to the system (e.g., inputs provided by the user). The policy check system can screen for personally identifiable information (PII), obscenities, sensitive topics, or other policy-based screening rules. The policy check system can screen any input provided by the user and strike it from further processing in any other model component.

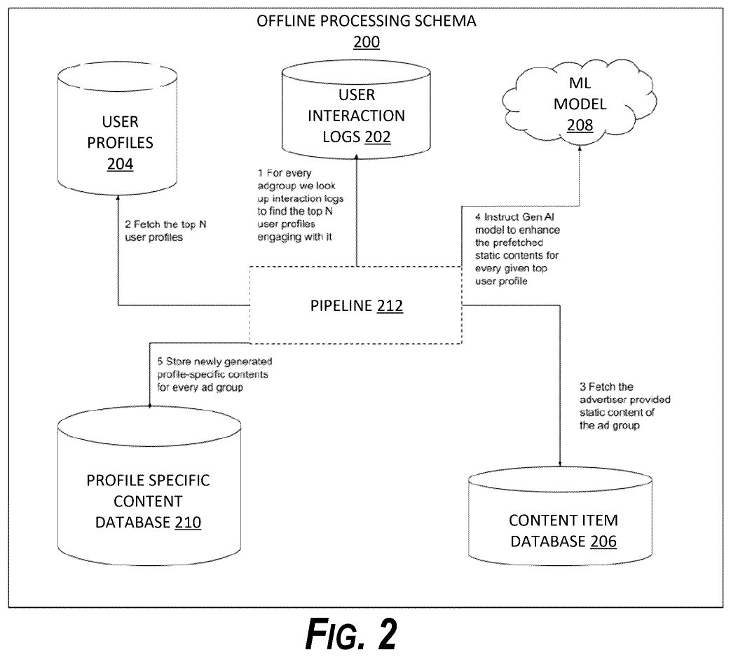

FIG. 2 depicts a block diagram of an offline processing schema 200 according to example embodiments of the present disclosure. In some instances, the system can obtain user interaction logs 202 for a content item. The system can determine a user profile for a group based on the information obtained from the user interaction logs 202. Based on the user interaction logs 202, the system can fetch all user profiles 204 and determine the top N profiles for every group that is engaged with the content item. Additionally, the system can fetch from a content item database 206 static content items and/or assets that have been provided by a content provider. The system can identify existing assets based on the information received and/or obtained from the content item database 206. Subsequently, the system can instruct the machine-learned model 208 to enhance the prefetch static content for every given top user profile associated with the content item. The machine-learned model 208 can generate new profile-specific content for every group. The system can customize a content item to target a user profile. For example, the system can modify (e.g., update) a static asset based on the specific user profile. The system can determine insights about the user and modify the static asset based on the insights. The system can store the new profile-specific content items in the generated profile-specific content database 210. In some instances, the system can include a pipeline 212 (e.g., Flume pipeline) orchestrating the offline generating pipeline.

The system can generate new assets based on the offline processing schema 200. The system can modify the new content item by adding (e.g., modifying) text, image, videos, and/or sitelinks. The text, image, videos, and/or sitelinks can be determined or generated based on information derived from the user profile. In some instances, the system can receive user input to customize the new content items that are generated. Additionally, the system can serve (e.g., present) the customized content items using AI-powered formats.

The machine-learned model 208 can include an overall model. The overall model can be a machine-learned generation model that is configured to generate a plurality of content items. Additionally, or alternatively, the overall model can be a machine-learned selection model that is configured to select a selected content item from the plurality of content items. In some implementations, the overall model is trained to receive a set of input data, provide output data that automatically generates new media assets and content items. For example, the system can receive, from a user device of a user, a content item associated with a content provider. The system can extract a plurality of assets (e.g., an image, a word, a video, or an audio file) from the content item. Additionally, the system, using the overall model (e.g., machine-learned generation model), can process the plurality of assets to generate the plurality of content items. Moreover, the system, using the overall model (e.g., a machine-learned selection model), can determine the selected content item from the plurality of content items. Subsequently, the system can cause the presentation of the selected content item on a graphical user interface displayed on the user device.

In another embodiment, the system can receive data indicating a request for a plurality of media assets that comprise multiple media modalities. Additionally, the system can obtain a media asset profile for a client account associated with the request. The media asset profile can include data indicating media asset preferences for the client account, and the media asset profile can be generated by processing pre-existing media assets associated with the client account. The system can generate, using a machine-learned model 208, the plurality of media assets based on the media asset profile by instructing an overall model (e.g., machine-learned asset generation model) to generate media assets that align with the media asset preferences. Subsequently, the system can send, based on receiving data indicating selection of one or more of the plurality of media assets, the one or more of the plurality of media assets to a content item generation system for generating content items using the one or more of the plurality of media assets.

The system can combine the best machine learning models, including generative AI, and deep insights to help fill out an entire asset group for most new campaigns automatically in real time. With one click, a client can immediately start with an asset group set to deliver results for client-specific goals, then be able to modify the content items and/or media assets based on suggestions received from the system. For example, the client can input as much or as little information to generate content items, and as the client generates these content items, the client can in some implementations be able to see the system's assumptions, have the opportunity to make refinements, and accept the media assets (e.g., content items) that the client wants. The client can publish the recommended media assets directly or just use them as a starting point to customize or build their own. The system can include a user interface framework for collecting inputs for intelligent asset creation, collection, and combination. The system can surface these assets and the system's assumptions back to clients (e.g., customers). The system can enable refinements of the media assets based on user input, all within the media asset construction process or onboarding flow process.

### Example Methods

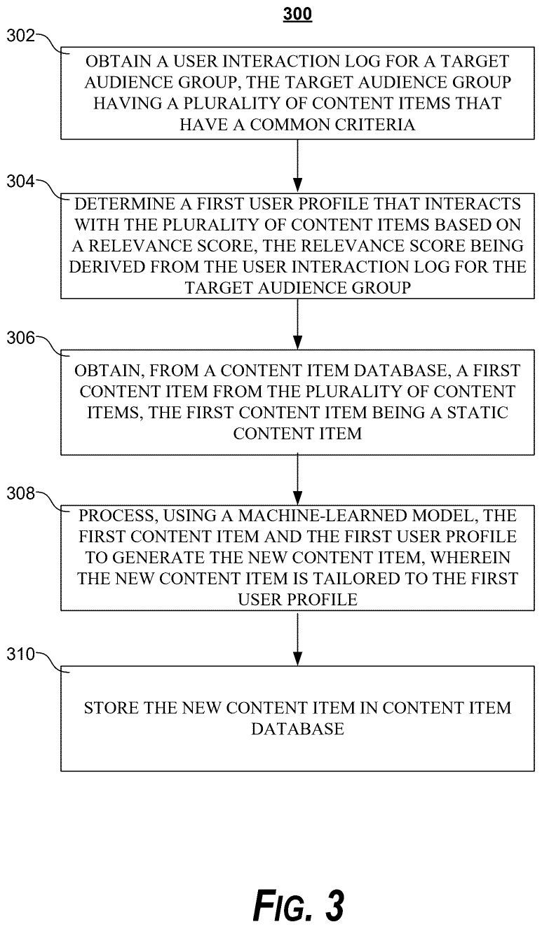

FIG. 3 depicts a flow chart diagram of an example method 300 for generating a new content item for a video platform according to example embodiments of the present disclosure. Example method 600 can be implemented by one or more computing systems (e.g., one or more computing systems as discussed with respect to FIGS. 1 to 2). Although FIG. 3 depicts steps performed in a particular order for purposes of illustration and discussion, the methods of the present disclosure are not limited to the particularly illustrated order or arrangement. The various steps of method 300 can be omitted, rearranged, combined, and/or adapted in various ways without deviating from the scope of the present disclosure.

At 302, a computing system can obtain a user interaction log for a target audience group. The target audience group can have a plurality of content items that have a similar (e.g., common) criteria.

At 304, the computing system can determine a first user profile that interacts with the plurality of content items based on a relevance score. The relevance score can be derived from the user interaction log for the target audience group.

At 306, the computing system can obtain, from a content item database, a first content item from the plurality of content items, the first content item being a static content item.

At 308, the computing system can process, using a machine-learned model, the first content item and the first user profile to generate the new content item, wherein the new content item is tailored to the first user profile.

At 310, the computing system can store the new content item in the content item database.

In some instances, the new content item is a video that is presented in the video platform.

In some instances, the static content item includes a text asset.

In some instances, the static content item includes an audio asset.

In some instances, the static content item includes an image asset.

In some instances, the static content item includes a video asset.

In some instances, the static content item includes two or more modalities selected from: text, image, audio, or video.

In some instances, the static content item is obtained from a content account. For example, the new content item is generated using information derived from an account profile of the client account.

In some instances, the method can further include generating the new content item by editing the first content item using at least one of the following editing operations: crop, rotate, infill, recolor, defocus, deblur, denoise, relight.

In some instances, the new content item is generated based on a parameter of the first user profile.

In some instances, the new content item is generated based on a set of content item guidelines for generating content items using the pre-existing image asset, the set of content item guidelines include resolution specifications, aspect ratio specifications, or orientation specifications.

In some instances, the method can further include determining, using the machine-learned model, a plurality of generated assets, wherein the machine-learned model is configured to identify asset characteristics associated with the first user profile, and wherein the new content item is generated using the plurality of generated assets.

In some instances, the method can further include ranking, using the machine-learned model, the plurality of generated assets by using a machine-learned ranking model to rank assets based on an estimated performance of the asset.

In some instances, the method can further include presenting, on a user interface accessible by a client account, the new content item for review. Additionally, the method can include receiving, via the user interface, inputs providing corrections to the new content item. Moreover, the method can include re-generating, using the machine-learned model, a second content item based on the received inputs.

In some instances, the user interface comprises a natural language input element for receiving corrective inputs in natural language format, wherein the natural language input element is configured to provide the received inputs.

In some instances, the new content item comprises two or more categories of the following categories: images, headlines, descriptions, videos, logos, colors, sitelinks, calls to action, audio.

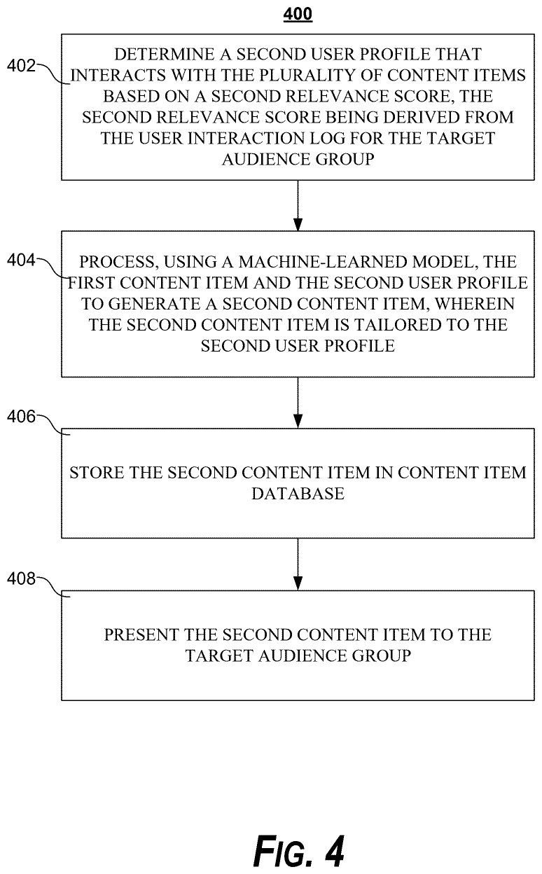

FIG. 4 depicts a flow chart diagram of an example method 400 to perform according to example embodiments of the present disclosure. Although FIG. 4 depicts steps performed in a particular order for purposes of illustration and discussion, the methods of the present disclosure are not limited to the particularly illustrated order or arrangement. The various steps of method 400 can be omitted, rearranged, combined, and/or adapted in various ways without deviating from the scope of the present disclosure.

At 402, a computing system can determine a second user profile that interacts with the plurality of content items based on a second relevance score, the second relevance score being derived from the user interaction log for the target audience group.

At 404, the computing system can process, using a machine-learned model, the first content item and the second user profile to generate a second content item, wherein the second content item is tailored to the second user profile.

At 406, the computing system can store the second content item in the content item database.

At 408, the computing system can present the second content item to the target audience group.

### Example Devices and Systems

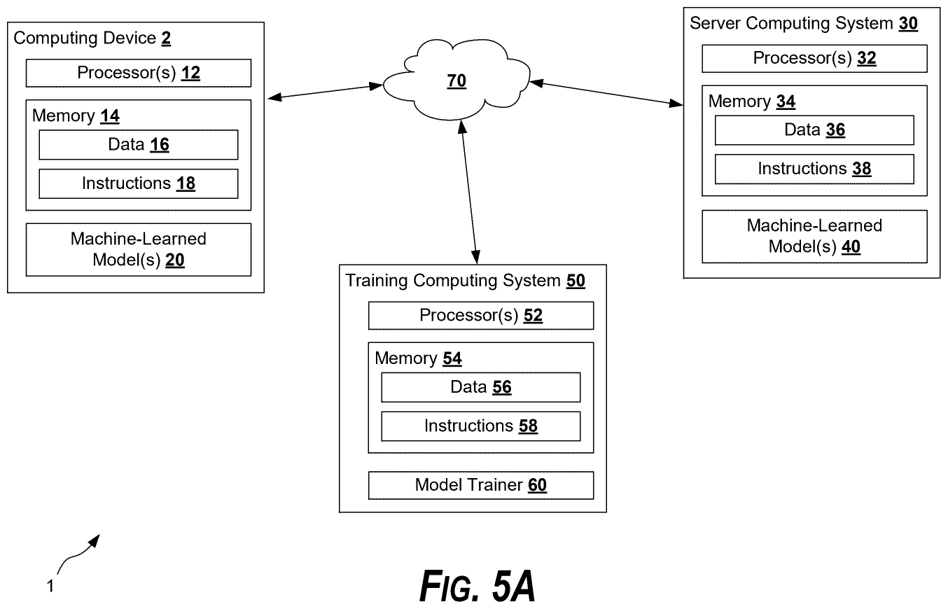

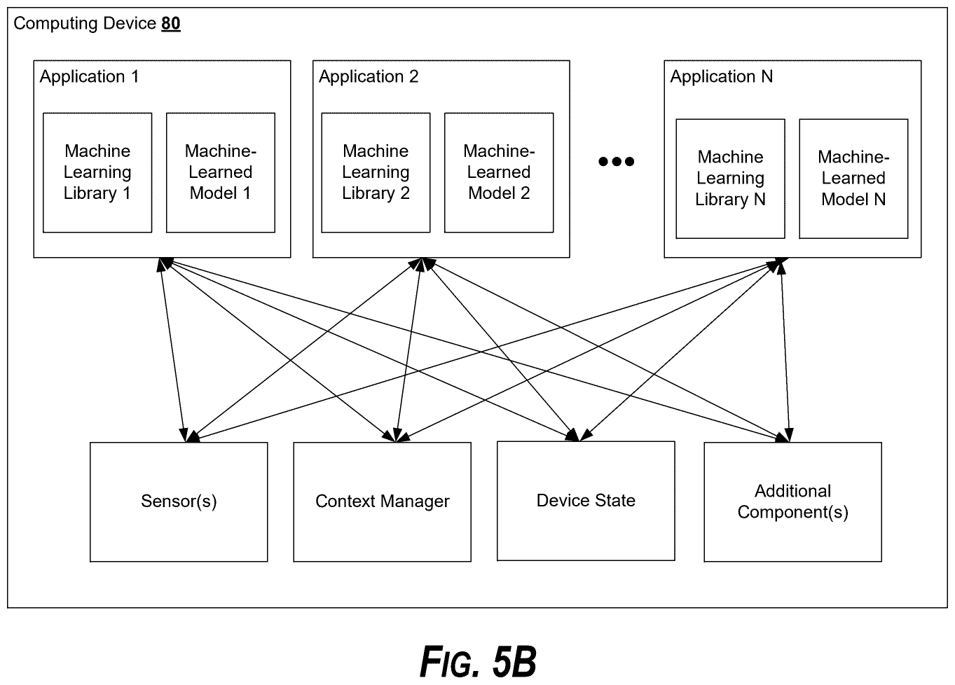

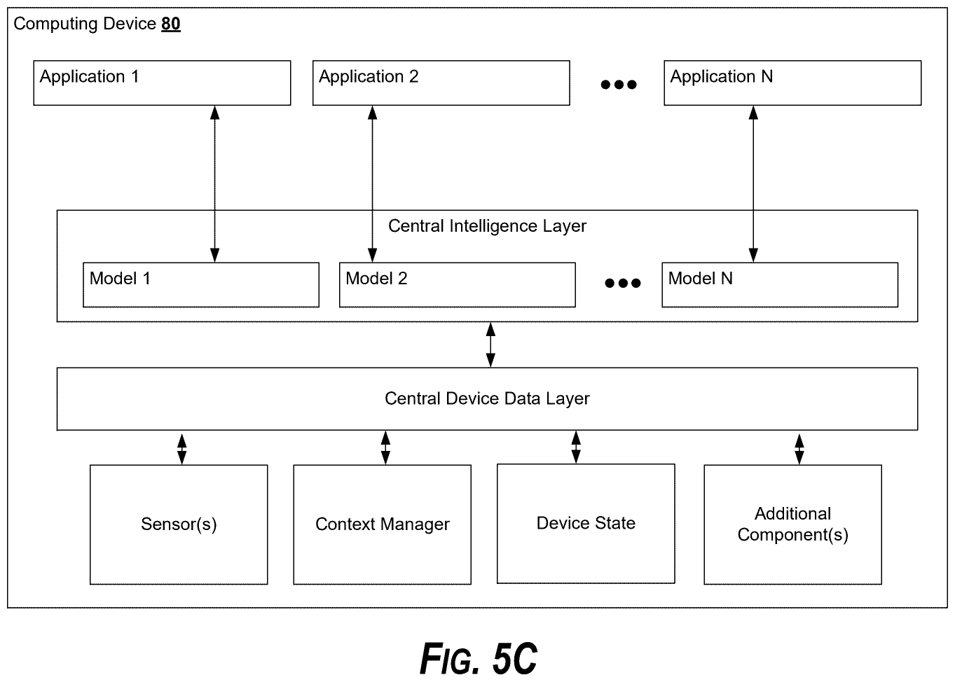

FIG. 5A depicts a block diagram of an example computing system 1 that can perform according to example embodiments of the present disclosure. The system 1 includes a computing device 2, a server computing system 30, and a training computing system 50 that are communicatively coupled over a network 70.

The computing device 2 can be any type of computing device, such as, for example, a personal computing device (e.g., laptop or desktop), a mobile computing device (e.g., smartphone or tablet), a gaming console or controller, a wearable computing device, an embedded computing device, or any other type of computing device. In some embodiments, the computing device 2 can be a client computing device. The computing device 2 can include one or more processors 12 and a memory 14. The one or more processors 12 can be any suitable processing device (e.g., a processor core, a microprocessor, an ASIC, an FPGA, a controller, a microcontroller) and can be one processor or a plurality of processors that are operatively connected. The memory 14 can include one or more non-transitory computer-readable storage media, such as RAM, ROM, EEPROM, EPROM, flash memory devices, magnetic disks, and combinations thereof. The memory 14 can store data 16 and instructions 18 which are executed by the processor 12 to cause the user computing device 2 to perform operations (e.g., to perform operations implementing input data structures and self-consistency output sampling according to example embodiments of the present disclosure).

In some implementations, the user computing device 2 can store or include one or more machine-learned models 20. For example, the machine-learned models 20 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, one or more machine-learned models 20 can be received from the server computing system 30 over network 70, stored in the computing device memory 14, and used or otherwise implemented by the one or more processors 12. In some implementations, the computing device 2 can implement multiple parallel instances of a machine-learned model 20.

Additionally, or alternatively, one or more machine-learned models 40 can be included in or otherwise stored and implemented by the server computing system 30 that communicates with the computing device 2 according to a client-server relationship.

Machine-learned model(s) 20 and 40 can include any one or more of the machine-learned models described herein, including the machine-learned asset generation pipeline and any of the component models therein.

The machine-learned models described in this specification may be used in a variety of tasks, applications, and/or use cases. Although described throughout with respect to example implementations for applications in medical domains, it is to be understood that the techniques described herein may be used for other tasks in various technological fields.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data). As another example, the machine-learned model(s) can process the image data to generate an encoded image data output (e.g., an encoded and/or compressed representation of the image data). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data). As another example, the machine-learned model(s) can process the speech data to generate an upscaled speech output (e.g., speech data that is higher quality than the input speech data). As another example, the machine-learned model(s) can process the speech data to generate a textual representation output (e.g., a textual representation of the input speech data). As another example, the machine-learned model(s) can process the speech data to generate a prediction output.

In some implementations, the input to the machine-learned model(s) of the present disclosure can be latent encoding data (e.g., a latent space representation of an input). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data, and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data, and the task is a computer vision task. In some cases, the input includes pixel data for one or more images, and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some embodiments, the machine-learned models 40 can be implemented by the server computing system 30 as a portion of a web service (e.g., remote machine-learned model hosting service, such as an online interface for performing machine-learned model operations over a network on remote servers 30). For instance, the server computing system 30 can communicate with the computing device 2 over a local intranet or internet connection. For instance, the computing device 2 can be a workstation or endpoint in communication with the server computing system 30, with implementation of the model 40 on the server computing system 30 being remotely performed and an output provided (e.g., cast, streamed) to the computing device 2. Thus, one or more models 20 can be stored and implemented at the user computing device 2 or one or more models 40 can be stored and implemented at the server computing system 30.

The computing device 2 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the computing device 2 is a user endpoint associated with a user account of a campaign generation system. The campaign generation system can operate on the server computing system 30.

The server computing system 30 can include one or more processors 32 and a memory 34. The one or more processors 32 can be any suitable processing device (e.g., a processor core, a microprocessor, an ASIC, an FPGA, a controller, a microcontroller) and can be one processor or a plurality of processors that are operatively connected. The memory 34 can include one or more non-transitory computer-readable storage media, such as RAM, ROM, EEPROM, EPROM, flash memory devices, magnetic disks, and combinations thereof. The memory 34 can store data 36 and instructions 38 which are executed by the processor 32 to cause the server computing system 30 to perform operations.

In some implementations, the server computing system 30 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 30 can store or otherwise include one or more machine-learned models 40. For example, the models 40 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

The computing device 2 or the server computing system 30 can train example embodiments of a machine-learned model (e.g., including models 20 or 40) using a training pipeline (e.g., an unsupervised pipeline, a semi-supervised pipeline). In some embodiments, the computing device 2 or the server computing system 30 can train example embodiments of a machine-learned model (e.g., including models 20 or 40) using a pre-training pipeline by interaction with the training computing system 50. In some embodiments, the training computing system 50 can be communicatively coupled over the network 70. The training computing system 50 can be separate from the server computing system 30 or can be a portion of the server computing system 30.

The training computing system 50 can include one or more processors 52 and a memory 54. The one or more processors 52 can be any suitable processing device (e.g., a processor core, a microprocessor, an ASIC, an FPGA, a controller, a microcontroller) and can be one processor or a plurality of processors that are operatively connected. The memory 54 can include one or more non-transitory computer-readable storage media, such as RAM, ROM, EEPROM, EPROM, flash memory devices, magnetic disks, and combinations thereof. The memory 54 can store data 56 and instructions 58 which are executed by the processor 52 to cause the training computing system 50 to perform operations (e.g., to perform operations implementing input data structures and self-consistency output sampling according to example embodiments of the present disclosure). In some implementations, the training computing system 50 includes or is otherwise implemented by one or more server computing devices.

The model trainer 60 can include a training pipeline for training machine-learned models using various objectives. Parameters of the image-processing model(s) can be trained, in some embodiments, using various training or learning techniques, such as, for example, backwards propagation of errors. For example, an objective or loss can be back propagated through the pretraining pipeline(s) to update one or more parameters of the model(s) (e.g., based on a gradient of the loss function). Various determinations of loss can be used, such as mean squared error, likelihood loss, cross entropy loss, hinge loss, or various other loss functions. Gradient descent techniques can be used to iteratively update the parameters over a number of training iterations. In some implementations, performing backwards propagation of errors can include performing truncated backpropagation through time. The pretraining pipeline can perform a number of generalization techniques (e.g., weight decays, dropouts) to improve the generalization capability of the models being trained.

The model trainer 60 can train one or more machine-learned models 20 or 40 using training data (e.g., data 56). The training data can include, for example, historical performance data, past user interactions, and/or past campaigns.

The model trainer 60 can include computer logic utilized to provide desired functionality. The model trainer 60 can be implemented in hardware, firmware, or software controlling a general-purpose processor. For example, in some implementations, the model trainer 60 includes program files stored on a storage device, loaded into a memory, and executed by one or more processors. In other implementations, the model trainer 60 includes one or more sets of computer-executable instructions that are stored in a tangible computer-readable storage medium such as RAM, hard disk, or optical or magnetic media.

The network 70 can be any type of communications network, such as a local area network (e.g., intranet), wide area network (e.g., Internet), or some combination thereof and can include any number of wired or wireless links. In general, communication over the network 70 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

FIG. 5A illustrates one example computing system that can be used to implement the present disclosure. Other computing systems can be used as well. For example, in some implementations, the computing device 2 can include the model trainer 60. In some implementations, the computing device 2 can implement the model trainer 60 to personalize the model(s) based on device-specific data.

FIG. 5B depicts a block diagram of an example computing device 80 that performs according to example embodiments of the present disclosure. The computing device 80 can be a user computing device or a server computing device. The computing device 80 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, and a browser application. As illustrated in FIG. 5B, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 5C depicts a block diagram of an example computing device 80 that performs according to example embodiments of the present disclosure. The computing device 80 can be a user computing device or a server computing device. The computing device 80 can include a number of applications (e.g., applications 1 through N). Each application is in communication with a central intelligence layer. Example applications include a text messaging application, an email application, a dictation application, a virtual keyboard application, and a browser application. In some implementations, each application can communicate with the central intelligence layer (and model(s) stored therein) using an API (e.g., a common API across all applications).

The central intelligence layer can include a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 80.

The central intelligence layer can communicate with a central device data layer. The central device data layer can be a centralized repository of data for the computing device 80. As illustrated in FIG. 5C, the central device data layer can communicate with a number of other components of the computing device, such as, for example, one or more sensors, a context manager, a device state component, or additional components. In some implementations, the central device data layer can communicate with each device component using an API (e.g., a private API).

### ADDITIONAL DISCLOSURE

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example of how implementations can operate or be configured is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but.” It should be understood that such conjunctions are provided for explanatory purposes only. Clauses and other sequences of items joined by a particular conjunction such as “or,” for example, can refer to “and/or,” “at least one of,” “any combination of” example elements listed therein. Also, terms such as “based on” should be understood as “based at least in part on.”

What is claimed is:

1. A computer-implemented method for generating a new content item for a video platform, comprising:
obtaining a user interaction log for a target audience group, the target audience group having a plurality of content items that have a similar criteria;
determining a first user profile that interacts with the plurality of content items based on a relevance score, the relevance score being derived from the user interaction log for the target audience group;
obtaining, from a content item database, a first content item from the plurality of content items, the first content item being a static content item;
processing, using a machine-learned model, the first content item and the first user profile to generate the new content item, wherein the new content item is tailored to the first user profile; and
storing the new content item in the content item database.

2. The computer-implemented method of claim 1, wherein the new content item is a video that is presented in the video platform.

3. The computer-implemented method of claim 1, wherein static content item includes a text asset.

4. The computer-implemented method of claim 1, wherein the static content item includes an audio asset.

5. The computer-implemented method of claim 1, wherein the static content item includes an image asset.

6. The computer-implemented method of claim 1, wherein the static content item includes a video asset.

7. The computer-implemented method of claim 1, wherein the static content item includes two or more modalities selected from: text, image, audio, or video.

8. The computer-implemented method of claim 1, wherein the static content item is obtained from a content account.

9. The computer-implemented method of claim 8, wherein the new content item is generated using information derived from an account profile of a client account.

10. The computer-implemented method of claim 1, comprising:
generating the new content item by editing the first content item using at least one of the following editing operations: crop, rotate, infill, recolor, defocus, deblur, denoise, relight.

11. The computer-implemented method of claim 1, wherein the new content item is generated based on a parameter of the first user profile.

12. The computer-implemented method of claim 1, wherein the new content item is generated based on a set of content item guidelines for generating content items using a pre-existing image asset, the set of content item guidelines include resolution specifications, aspect ratio specifications, or orientation specifications.

13. The computer-implemented method of claim 1, comprising:
determining, using the machine-learned model, a plurality of generated assets, wherein the machine-learned model is configured to identify asset characteristics associated with the first user profile, and wherein the new content item is generated using the plurality of generated assets.

14. The computer-implemented method of claim 13, comprising:
ranking, using the machine-learned model, the plurality of generated assets by using a machine-learned ranking model to rank assets based on an estimated performance of the assets.

15. The computer-implemented method of claim 1, comprising:
presenting, on a user interface accessible by a client account, the new content item for review;
receiving, via the user interface, inputs providing corrections to the new content item; and
re-generating, using the machine-learned model, a second content item based on the received inputs.

16. The computer-implemented method of claim 15, wherein the user interface comprises a natural language input element for receiving corrective inputs in natural language format, wherein the natural language input element is configured to provide the received inputs.

17. The computer-implemented method of claim 1, wherein the new content item comprises two or more categories of the following categories: images, headlines, descriptions, videos, logos, colors, sitelinks, calls to action, audio.

18. The computer-implemented method of claim 1, the method further comprising:
determining a second user profile that interacts with the plurality of content items based on a second relevance score, the second relevance score being derived from the user interaction log for the target audience group;
processing, using a machine-learned model, the first content item and the second user profile to generate a second content item, wherein the second content item is tailored to the second user profile; and
storing the second content item in the content item database.

19. One or more non-transitory, computer readable media storing instructions that are executable by one or more processors to cause a computing system to perform operations, the operations comprising:
obtaining a user interaction log for a target audience group, the target audience group having a plurality of content items that have a similar criteria;
determining a first user profile that interacts with the plurality of content items based on a relevance score, the relevance score being derived from the user interaction log for the target audience group;
obtaining, from a content item database, a first content item from the plurality of content items, the first content item being a static content item;
processing, using a machine-learned model, the first content item and the first user profile to generate a new content item, wherein the new content item is tailored to the first user profile; and
storing the new content item in the content item database.

20. A computing system for generating a new content item for a video platform, comprising:
one or more processors;
one or more non-transitory computer-readable media that collectively store a machine-learned model, wherein the machine-learned model is configured to generate the new content item; and
instructions that, when executed by the one or more processors, cause the computing system to perform operations, the operations comprising:
obtaining a user interaction log for a target audience group, the target audience group having a plurality of content items that have a similar criteria;
determining a first user profile that interacts with the plurality of content items based on a relevance score, the relevance score being derived from the user interaction log for the target audience group;
obtaining, from a content item database, a first content item from the plurality of content items, the first content item being a static content item;
processing, using the machine-learned model, the first content item and the first user profile to generate a new content item, wherein the new content item is tailored to the first user profile; and
storing the new content item in the content item database.
